(19) United States
(12) Patent Application Publication
(10) Pub. No.: US 2012/0166697 A1
(43) Pub. Date: Jun. 28, 2012

(54) ELECTRONIC DEVICE WITH POWER OUTPUT FUNCTION

(75) Inventors: SHA-SHA HU, Shenzhen City (CN); TING GONG, Shenzhen City (CN); BO-CHING LIN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/174,788

(22) Filed: Jul. 1, 2011

(30) Foreign Application Priority Data
Dec. 28, 2010 (CN) 201010608982.4

(51) Int. Cl. G06F 13/00; H02J 7/00

(52) U.S. Cl. 710/300; 320/107

(57) ABSTRACT

An electronic device with power output function includes an interface for connecting with an external power supply or a small electronic device. The electronic device further includes a battery, a boost circuit, a switch circuit, and a charging circuit. When the external power supply is connected to the electronic device through a first cable, the switch circuit is closed to allow the external power supply to charge the battery through the first cable, the interface, the switch circuit, and the charging circuit. When the small electronic device is connected to the electronic device through a second cable, the boost circuit is enabled to boost the power voltage of the battery to allow the battery to charge the small electronic device through the boost circuit, the interface, and the second cable.

### BACKGROUND

1. Technical Field

The present disclosure relates to an electronic device, and particularly, to an electronic device that can share battery power with other devices.

2. Description of Related Art

Electronic devices like ebook readers, tablet PCs, and mobile phones have built-in batteries which can be charged by a power supply through a USB interface. However, the built-in battery can only provide electricity to the electronic device which it belongs to rather than other electronic devices, and thus limiting the flexibility of the power usage between different electronic devices.

Therefore, what is needed is an electronic device with power output function.

### BRIEF DESCRIPTION OF THE DRAWINGS

The components in the drawings are not necessarily drawn to scale, the emphasis instead being placed upon clearly illustrating the principles of an electronic device with outward power supply capability. Moreover, in the drawings, like reference numerals designate corresponding parts throughout the several views.

FIG. 1 is a block diagram of an electronic device in accordance with one exemplary embodiment.

FIG. 2 is a circuit diagram of the electronic device of FIG. 1, in accordance with an exemplary embodiment.

FIG. 3 is a diagram of a first USB cable used with the electronic device of FIG. 1, in accordance with an exemplary embodiment.

FIG. 4 is a diagram of a second USB cable used with the electronic device of FIG. 1, in accordance with an exemplary embodiment.

### DETAILED DESCRIPTION

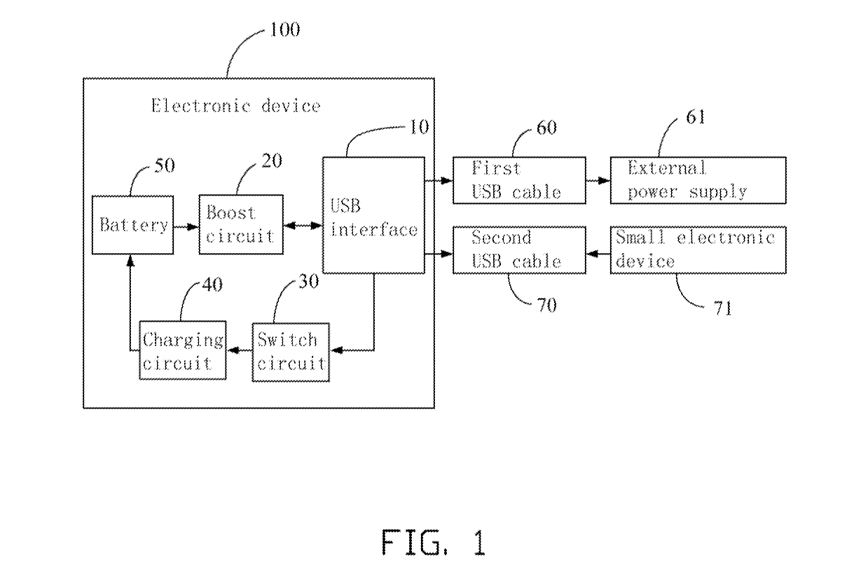

Referring to FIG. 1, an electronic device 100 includes a USB interface 10, a boost circuit 20, a switch circuit 30, a charging circuit 40, and a battery 50. The USB interface 10 can be connected with an external power supply 61 through a first USB cable 60, or connected with a small electronic device 71 through a second USB cable 70. When the USB interface 10 is connected with the external power supply 61, the external power supply 61 charges the battery 50 through the first USB cable 60, the USB interface 10, the switch circuit 30, and the charging circuit 40. When the USB interface 10 is connected with the small electronic device 71, the battery 50 supplies power to the small electronic device 71 through the boost circuit 20, the USB interface 10, and the second USB cable 70. In the present embodiment, the external power supply 61 is USB power of a computer, the electronic device 100 is an ebook reader, and the small electronic device 71 is a mobile phone. In other embodiments, the external power supply 61 or the small electronic device 71 can be another electronic device 100.

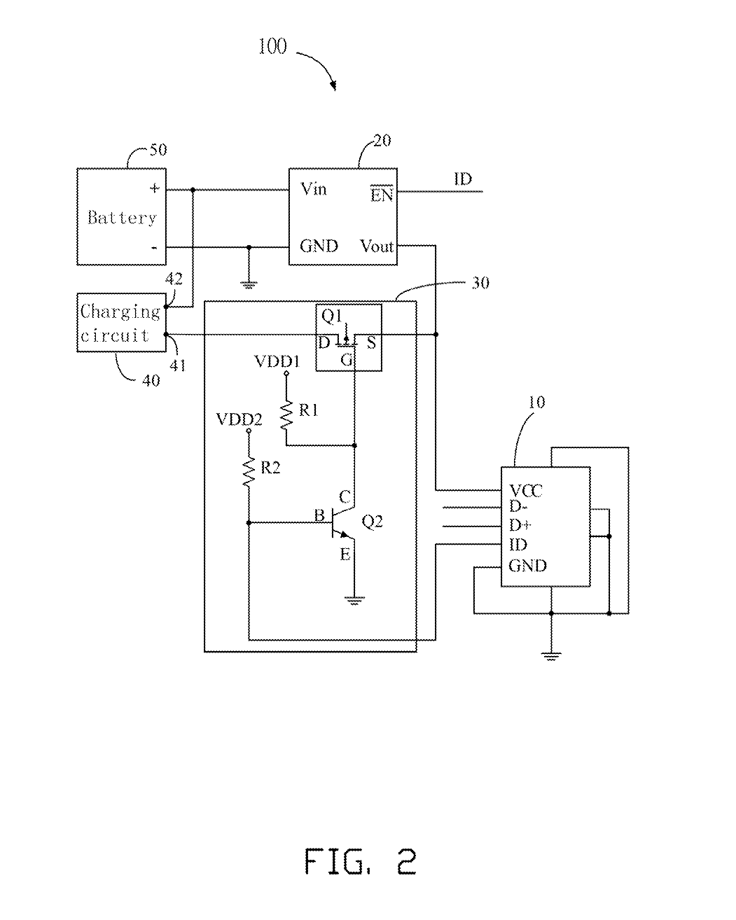

Referring to FIG. 2, in one embodiment, the USB interface 10 is a 5 pin mini USB interface having a VCC pin, a D− pin, a D+ pin, an ID pin, and a GND pin. The electronic device 100 determines whether the external power supply 61 or the small electronic device 71 is connected to the USB interface 10 by a voltage level of the ID pin, and the voltage level of the ID pin is determined by whether the first USB cable 60 or the second USB cable 70 connected with the USB interface 10.

The switch circuit 30 includes a switch Q1 and a switch Q2. The switch Q1 is a pMOSFET having a source, a drain, and a gate, and the switch Q2 is a npn transistor having an emitter, a collector, and a base. The charging circuit 40 includes a power input terminal 41 connected with the switch circuit 30 and a power output terminal 42 connected with the battery 50. The source, the drain, and the gate of the switch Q1 are connected to the VCC pin of the USB interface 10, the power input terminal 41 of the charging circuit 40, and the collector of the switch Q2, respectively; the gate of the switch Q1 further connects to a power terminal VDD1 through a pull-up resistor R1. The emitter, the collector, and the base of the switch Q2 are connected to ground, the gate of the switch Q1, and the ID pin of the USB interface 10, and the base of the switch Q2 further connects to a power terminal VDD2 through a pull-up resistor R2. The power terminal VDD1 and VDD2 are connected to the positive electrode of the battery 50. The charging circuit 40 can receive power from the external power supply 61 through the power input terminal 41 and charge the battery 50 through the power output terminal 42.

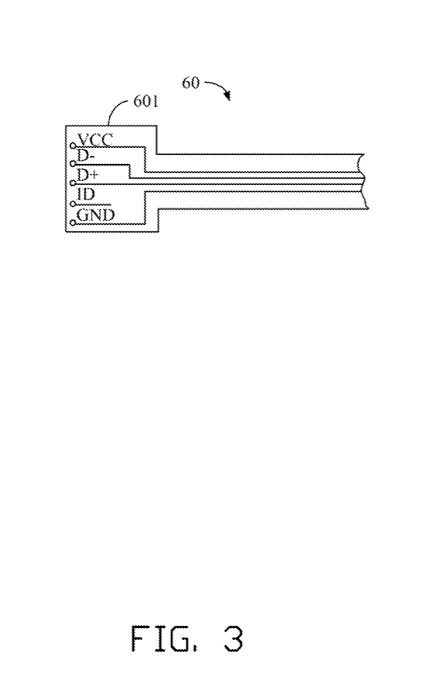

Referring to FIG. 3, the first USB cable 60 has a first USB cable interface 601. In the present embodiment, the first USB cable interface 601 is a 5 pin mini USB interface, and an ID pin of the first USB cable interface 601 is floating. When the external power supply 61 is connected to the USB interface 10 through the first USB cable 60, the first USB cable interface 601 leaves the ID pin of the USB interface 10 floating. When the ID pin of the USB interface 10 is allowed to float, the base of the switch Q2 obtains a high voltage level through the power terminal VDD2 and the pull-up resistor R2, and thus closes the switch Q2. When the switch Q2 is closed, the gate of the switch Q1 is grounded and at a low voltage level, and thus closes the switch Q1. When the switch Q1 is closed, the external power supply 61 can charge the battery 50 through the first USB cable 60, the USB interface 10, the switch circuit 30, and the charging circuit 40.

Referring to FIG. 2, in the present embodiment, the boost circuit 20 is a direct current (DC)/DC boost circuit connected between the battery 50 and the interface 10, and boosts a voltage from the battery 50 and transfers the boosted voltage to the USB interface 10. The boost circuit 20 is enabled when an enable terminal (EN), connected to the ID pin of the USB interface 10, is at a low voltage level, and stops working when the enable terminal is at a high voltage level.

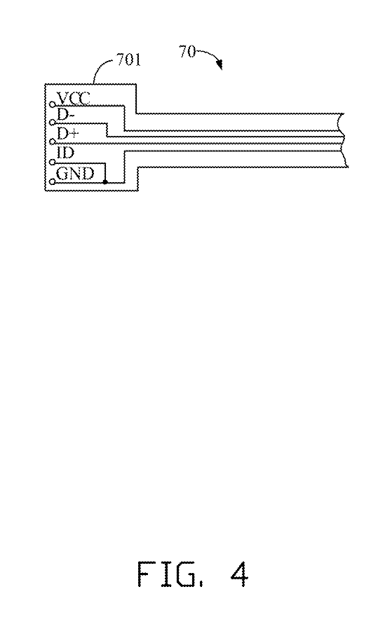

Referring to FIG. 4, the second USB cable 70 has a second USB cable interface 701. In the present embodiment, the second USB cable interface 701 is a 5 pin mini USB interface, and an ID pin of the second USB cable interface 701 is grounded through a GND pin of the second USB cable interface 701. When the small electronic device 71 is connected to the USB interface 10 through the second USB cable 70, the second USB cable interface 701 grounds the ID pin of the USB interface 10 to apply a low voltage level to the enable terminal of the boost circuit 20, and the battery 50 supplies power to the small electronic device 71 through the boost circuit 20, the USB interface 10, and the second USB cable 70. In the present embodiment, the boost circuit 20 can convert the battery voltage from 4.2V to 5V for charging the small electronic device 71.

Therefore, when the small electronic device 71 is connected to the electronic device 100 through the second USB cable 70, the boost circuit 20 is enabled to charge the small electronic device 71. When the external power supply 61 is connected with the electronic device 100 through the first USB cable 60, the switch circuit 30 is closed to allow the external power supply 61 to charge the battery 50.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
an interface for connecting with an external power supply or a small electronic device;
a battery for powering the small electronic device, or being charged by the external power supply;
a boost circuit for boosting an voltage output of the battery to supply a boosted voltage to the small electronic device, wherein the boost circuit is connected between the battery and the interface;
a switch circuit for switching the external power supply to charge the battery; and
a charging circuit for charging the battery.

2. The electronic device as claimed in claim 1, wherein the external power supply charges the battery through the interface, the switch circuit, and the charging circuit.

3. The electronic device as claimed in claim 1, wherein the external power supply connects to the interface through a first cable, and the switch circuit is closed when the first cable is connected to the interface.

4. The electronic device as claimed in claim 3, wherein the switch circuit comprises a first switch for controlling the connection between the interface and the charging circuit, and a second switch for controlling the first switch; the second switch is closed when the first cable is connected to the interface; when the second switch is closed, the first switch is closed and the battery of the electronic device can be charged by the external power supply.

5. The electronic device as claimed in claim 4, wherein the interface is a mini USB interface with an ID pin; the first switch is a pMOSFET, and the second switch is a NPN transistor; a base of the second switch is connected with the ID pin, and a collector of the second switch is connected with a gate of the first switch while an emitter of the second switch is grounded; a drain and a source of the first switch are connected with the charging circuit and the interface, respectively; the gate of the first switch is further connected to a first power output terminal through a first pull up resistor, and the base of the second switch is further connected to a second power output terminal through a second pull up resistor.

6. The electronic device as claimed in claim 5, wherein the second switch is closed when the base of the second switch is at a high voltage level.

7. The electronic device as claimed in claim 6, wherein the first cable leaves the ID pin floating to allow the second switch to obtain the high voltage level when the first cable is connected with the interface.

8. The electronic device as claimed in claim 1, wherein the battery charges the small electronic device through the boost circuit and the interface.

9. The electronic device as claimed in claim 1, wherein the small electronic device connects to the interface through a second cable, and the boost circuit is enabled when the second cable is connected to the interface.

10. The electronic device as claimed in claim 9, wherein the interface is a mini USB interface with an ID pin, and an enable terminal of the boost circuit is connected with the ID pin; the enable terminal is enabled when the second cable is connected with the interface to enable the boost circuit; the boost circuit can supply the boosted power to the small electronic device when the boost circuit is enabled.

11. The electronic device as claimed in claim 10, wherein the enable terminal is enabled when the enable terminal is at a low voltage level.

12. The electronic device as claimed in claim 11, wherein the second cable grounds the ID pin to allow the enable terminal to obtain the low voltage level when the second cable is connected with the interface.
